(19) United States
(12) Patent Application Publication
(10) Pub. No.: US 2014/0057126 A1
(43) Pub. Date: Feb. 27, 2014

(54) Method Of Manufacturing A Workpiece With Multiple Metal Layers

(71) Applicants: (Dongguan) Grand Fame Industrial Limited, Dongguan City (CN); Zoltrix Material (Guangzhou) Limited, Guangzhou (CN)

(72) Inventors: Chi Hung Kevin LIU, Guangzhou (CN); Chi Hung HO, Guangzhou (CN)

(73) Assignees: (Dongguan) Grand Fame Industrial Limited, Dongguan City (CN); Zoltrix Material (Guangzhou) Limited, Guangzhou (CN)

(21) Appl. No.: 14/065,763

(22) Filed: Oct. 29, 2013

Related U.S. Application Data
(62) Division of application No. 13/747,833, filed on Jan. 23, 2013.
Application No. 13/747,833 is a continuation-in-part of application No. 13/651,980, filed on Oct. 15, 2012, now abandoned.
Application No. 13/651,980 is a continuation-in-part of application No. 13/277,673, filed on Oct. 20, 2011, now abandoned.

(30) Foreign Application Priority Data
Feb. 1, 2011 (CN) 201100378281.4

(51) Int. Cl. B32B 7/08; B32B 15/01

(52) U.S. Cl. CPC B32B 7/08; B32B 15/01
USPC 428/596; 428/615; 428/600; 428/614

(57) ABSTRACT

A method of manufacturing a workpiece with multiple metal layers is disclosed as including steps (a) providing a mold with at least a runner and a cavity, (b) providing in the cavity of the mold a first metal layer made of a first metal, the first metal layer having a surface which is roughened and/or includes an engagement structure, and (c) injecting a molten second metal onto the surface of the first metal layer to form a second metal layer on the first metal layer in which the second metal layer engages with the roughened surface of the first metal layer or with the engagement structure of the surface of the first metal layer, and the molten second metal enters the cavity of the mold at a speed of at least 70 meters per second (m/s).

### CROSS REFERENCE TO RELATED APPLICATIONS

This application is a Division of U.S. patent application Ser. No. 13/747,833, filed 23 Jan. 2013, now pending which was a continuation-in-part of U.S. patent application Ser. No. 13/651,980 filed on 15 Oct. 2012, which is itself a continuation-in-part of U.S. patent application Ser. No. 13/277,673 filed on 20 Oct. 2011, which claims priority in Chinese Patent Application no. 2011 0037281.4, filed Feb. 1, 2011, the contents of these applications being incorporated herein in their entirety by reference.

### FIELD OF THE INVENTION

The present invention relates to a method of manufacturing a workpiece, such as a plate, with multiple metal layers. For the purpose of this invention, where the context allows, the terms “metal” and “metals” shall also include “alloys of metal” and “alloys of metals” respectively. It should also be understood that, for the purpose of this invention, the metal layers may be made of a same metal or different metals.

### BACKGROUND OF THE INVENTION

With the rapid development in the communication, consumer electronic and computer industries (so called “3C industries”), consumers not only expect good performance of such products (so called “3C products”) (such as processing speed and storage capacity), but also a high class and durable cosmetic surface of such products. A metal casing with good strength and light weight will thus become more and more important to 3C products. Such characteristics have also become the consumer requirements or expectation of products in other industries, such as the household industry and automotive industry. In most products, there is a need to over-mold at least one metal layer onto another metal layer, for example to form a cover or a plate. There is therefore a need to improve the joining or bonding strength between two metal layers, which has become a significant production requirement.

A conventional colorful plastic casing of an electronic product is easily broken and damaged by external impact, while a casing of a single metal layer may rust due to environmental factors, or subsequent surface treatment cannot be performed on the casing due to the limitation of material properties. Therefore, casings with multiple metal layers with thin thickness, good cosmetic performance, good strength for resisting external impact, and good corrosion resistance are needed to solve the various shortcomings of casings of a single metal layer. In the prior art, a casing for a consumer electronic apparatus which is formed of double metal layers or of a mechanical laminate of materials is usually prepared by vacuum evaporation or ion sputtering, which entails high manufacturing cost. However, as such a prior art casing is not good for receiving surface treatment involving wet process, such as plating and anodizing, it is less corrosion resistant.

In conventional techniques, solid-state welding processes (such as cold welding, friction welding and ultrasonic welding) may be used for bonding a veneer to a cast metal part. However, such solid-state welding processes may significantly increase the complexity and cost of the processing flow. Therefore, persons skilled in the art are still looking for effective methods of manufacturing a workpiece with multiple metal layers which is less costly and less complex.

In addition, there is an ever-increasing requirement for electronic products (such as tablet computers and smart phones) and domestic electrical appliances to be as compact and slim as possible. Consumers also make the same requirements on products in the automotive industry and household product industry. Consumers are at the same time making a higher and higher demand on the functions and capability of such products. Manufacturers are thus looking for ways to make bodies of the products as compact as possible while retaining sufficient space for housing the necessary components. Existing methods do not allow a thin layer of metal to be injected onto and bonded/engaged with a layer of metal to form a workpiece with multiple metal layers. In addition, as such products get compacter and slimmer, problems arise as regards post-treatment, such as trimming and computer numerical control (CNC) works, which are required for achieving the necessary features.

As such products get more and more compact and slim, problems arise as regards post-treatment (such as trimming) of such workpieces as covers, housings, casings and chassis, because such post-treatment will exert pressure on the workpieces, which may deform the workpieces.

It is thus an object of the present invention to provide a method of manufacturing a workpiece with multiple metal layers, a mold and a workpiece with multiple metal layers in which the aforesaid shortcomings are mitigated or at least to provide a useful alternative to the trade and public.

### SUMMARY OF THE INVENTION

According to a first aspect of the present invention, there is provided a method of manufacturing a workpiece with multiple metal layers, the method including the steps of (a) providing a mold with at least a runner, a gate and a cavity, (b) providing in the cavity of the mold a first metal layer made of a first metal, the first metal layer having a surface, the surface being roughened and/or including at least one engagement structure, and (c) injecting a molten second metal onto the surface of the first metal layer to form a second metal layer on the first metal layer wherein said second metal layer engages with said roughened surface of said first metal layer or with said engagement structure of said surface of said first metal layer, wherein said molten second metal enters said cavity of said mold at a speed of at least substantially 70 meters per second (m/s).

According to a second aspect of the present invention, there is provided a mold including a first mold piece and a second mold piece, wherein said first mold piece and said second mold piece are movable relative to each other between an open configuration in which said first mold piece and said second mold piece are detached from each other and a closed configuration for holding a semi-finished workpiece between said first mold piece and said second mold piece, and wherein at least said first mold piece includes a wall member which, when said mold is in said closed configuration and holds a semi-finished workpiece, punches into at least part of said semi-finished workpiece to form a seal between said wall member and said semi-finished workpiece which prevents flow of a fluid through said seal.

According to a third aspect of the present invention, there is provided a workpiece with multiple metal layers, said workpiece being formed by injecting at least a second metal layer onto a first metal layer, wherein each of said first metal layer and second metal layer includes at least one engagement structure.

According to a fourth aspect of the present invention, there is provided a mold including a first mold piece and a second mold piece, wherein said first mold piece and said second mold piece are movable relative to each other between an open configuration in which said first mold piece and said second mold piece are detached from each other and a closed configuration in which said first mold piece and said mold piece are engaged with each other to form a cavity for containing a semi-finished workpiece, wherein said first mold piece includes a passageway allowing supply of molding material into said cavity, and wherein said mold is without a channel allowing flow of molding material out of said cavity.

According to a fifth aspect of the present invention, there is provided a method of manufacturing a workpiece with multiple metal layers, said method including steps (a) providing a first metal layer made of a first metal, (b) pre-treating said first metal layer, (c) placing said pre-treated first metal layer in a mold, and (d) injecting a molten second metal onto said surface of said pre-treated first metal layer to form a second metal layer on said pre-treated first metal layer.

According to a sixth aspect of the present invention, there is provided a workpiece with multiple metal layers, said workpiece being formed by injecting at least a second metal layer onto a first metal layer, wherein said second metal layer is of a thickness of not more than substantially 0.5 mm.

According to a seventh aspect of the present invention, there is provided a method of manufacturing a workpiece with multiple metal layers, said method including steps (a) providing a mold with at least a runner, a gate and a cavity, (b) providing a first metal layer made of a first metal, said first metal layer having a surface, said surface including at least one engagement structure, (c) pre-treating said first metal layer, (d) placing said pre-treated first metal layer in said mold, and (e) injecting a molten second metal onto said surface of said first pre-treated metal layer to form a second metal layer on said pre-treated first metal layer, wherein said molten second metal enters said cavity of said mold at a speed of at least substantially 70 meters per second (m/s), wherein said second metal layer includes at least one engagement structure which engages with said engagement structure of said surface of said pre-treated first metal layer, wherein said mold includes a first mold piece and a second mold piece, wherein said first mold piece and said second mold piece are movable relative to each other between an open configuration in which said first mold piece and said second mold piece are detached from each other and a closed configuration in which said first mold piece and said second mold piece are engaged with each other to form said cavity for containing said pre-treated first metal layer, wherein said first mold piece includes a passageway allowing supply of said molten second metal, and wherein said mold is without a channel allowing flow of said molten second metal out of said cavity.

According to an eighth aspect of the present invention, there is provided a workpiece with multiple metal layers formed of a method including steps (a) providing a mold with at least a runner, a gate and a cavity, (b) providing a first metal layer made of a first metal, said first metal layer having a surface, said surface including at least one engagement structure, (c) pre-treating said first metal layer, (d) placing said pre-treated first metal layer in said mold, and (e) injecting a molten second metal onto said surface of said first pre-treated metal layer to form a second metal layer on said pre-treated first metal layer, wherein said molten second metal enters said cavity of said mold at a speed of at least substantially 70 meters per second (m/s), wherein said second metal layer includes at least one engagement structure which engages with said engagement structure of said surface of said pre-treated first metal layer, wherein said mold includes a first mold piece and a second mold piece, wherein said first mold piece and said second mold piece are movable relative to each other between an open configuration in which said first mold piece and said second mold piece are detached from each other and a closed configuration in which said first mold piece and said second mold piece are engaged with each other to form said cavity for containing said pre-treated first metal layer, wherein said first mold piece includes a passageway allowing supply of said molten second metal, and wherein said mold is without a channel allowing flow of said molten second metal out of said cavity.

### BRIEF DESCRIPTION OF THE DRAWINGS

FIG. 1 illustrates a method of manufacturing a workpiece with multiple metal layers according to an embodiment of the present invention;

FIG. 2-1 illustrates a device of manufacturing a workpiece with multiple metal layers, for carrying out the method shown in FIG. 1, in which a mold in the device is in an open configuration;

FIG. 2-2 illustrates the device shown in FIG. 2-1 in which the mold is in a closed configuration;

FIG. 2-3 is a partially enlarged view of the mold shown in FIG. 2-2;

FIG. 3 illustrates a method of manufacturing a workpiece with multiple metal layers, according to a further embodiment of the present invention;

FIG. 4 illustrates a mold of manufacturing a workpiece with multiple metal layers, for carrying out the method shown in FIG. 3;

FIG. 5 illustrates a method of manufacturing a workpiece with multiple metal layers, according to a yet further embodiment of the present invention;

FIG. 6 illustrates a workpiece with multiple metal layers manufactured by the method shown in FIG. 5;

FIG. 7 illustrates a method of manufacturing a workpiece with multiple metal layers, according to a still further embodiment of the present invention;

FIG. 8 illustrates a first workpiece with multiple metal layers manufactured by the method shown in FIG. 7;

FIG. 9A illustrates a second workpiece with multiple metal layers manufactured by the method shown in FIG. 7;

FIG. 9B illustrates a third workpiece with multiple metal layers manufactured by the method shown in FIG. 7;

FIG. 10A to 10C illustrate the process whereby a second metal in molten form is injected into a mold to bond or engage with a first metal layer, in a method according to a further embodiment of the present invention;

FIG. 11 is a sectional view of an alternative mold suitable for use in a method according to the present invention;

FIG. 12 is a partial sectional view of the first metal layer of FIG. 11 after engagement with a second metal layer;

FIG. 13 is a side view of a first metal layer, after pre-treatment, and ready for injection of a molten second metal, according to a still further embodiment of the present invention;

FIG. 14A is a side view of a cover of multiple metal layers, including the first metal layer of FIG. 13;

FIG. 14B is a partial enlarged view of FIG. 14A; and

FIG. 15 is a top partial view of a cover of multiple metal layers with a thin bay covered in part by a second metal layer.

### DETAILED DESCRIPTION OF THE INVENTION

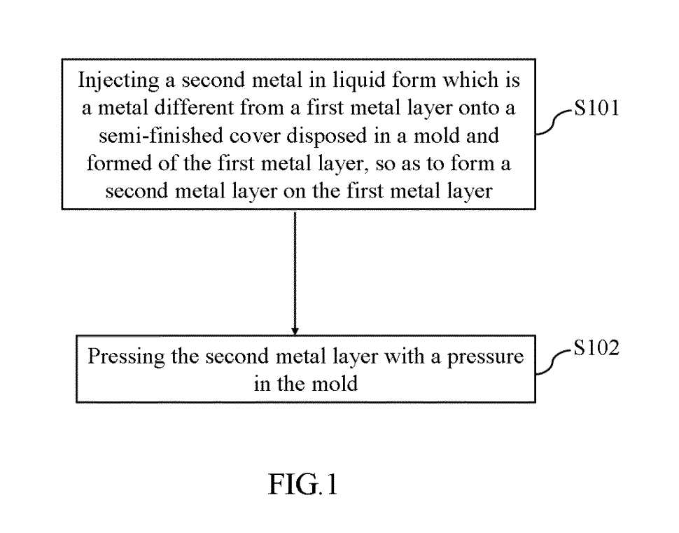

FIG. 1 illustrates a method of manufacturing a workpiece with multiple metal layers according to an embodiment of the present invention. Generally speaking, in this method, a first metal layer in the form of a semi-finished plate formed of a first metal is disposed in a mold. A second metal (which is different from the first metal) in liquid (molten) form is then injected into the mold and onto the plate, so as to form a second metal layer on the first metal layer (S101). The second metal layer in the mold is then pressed by a pressure in the mold (S102) to facilitate bonding of the second metal layer to and with the first metal layer. It should of course be understood that a third metal (which may be the same as or different from the first and second metals) in liquid form may be injected onto the first metal layer or the second metal layer to form a workpiece with three metal layers by repeating the above operation.

The injection operation includes different aspects, such as high-pressure and high speed injection molding, pouring and/or flowing. The pressure, the speed at which the second metal is injected into the mold and the short time duration in which the second metal covers the first metal layer all assist in improving the adhesiveness and strength of bonding between the first metal layer and the second metal layer, removing bubbles in the second metal when in liquid state, and improving the compactness of the second metal layer, so that only very few pores are left after cooling and curing of the second metal layer, thereby achieving the strength of a composite metal. Such may also prevent the formation of a liquid flow mark due to flowing of the second metal in liquid form during injection. Pressing the second metal layer may also enable a surplus of the second metal in liquid form to overflow.

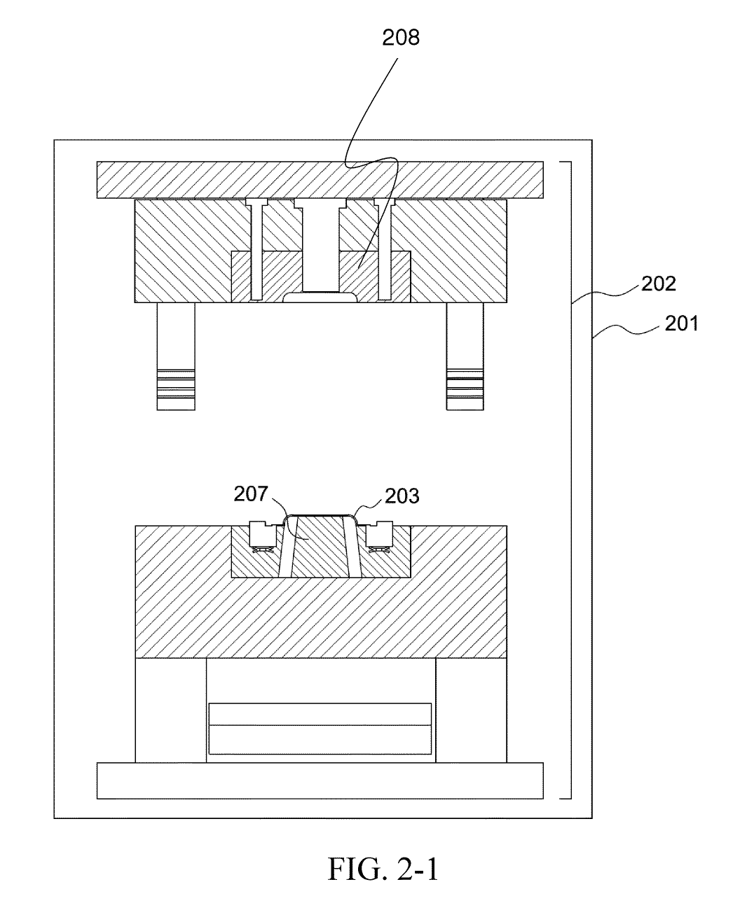

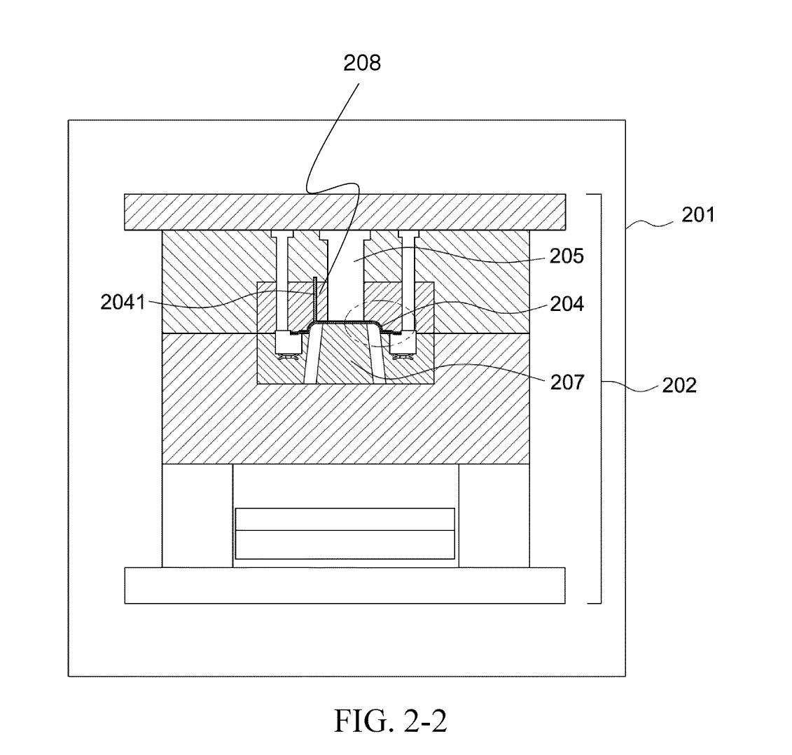

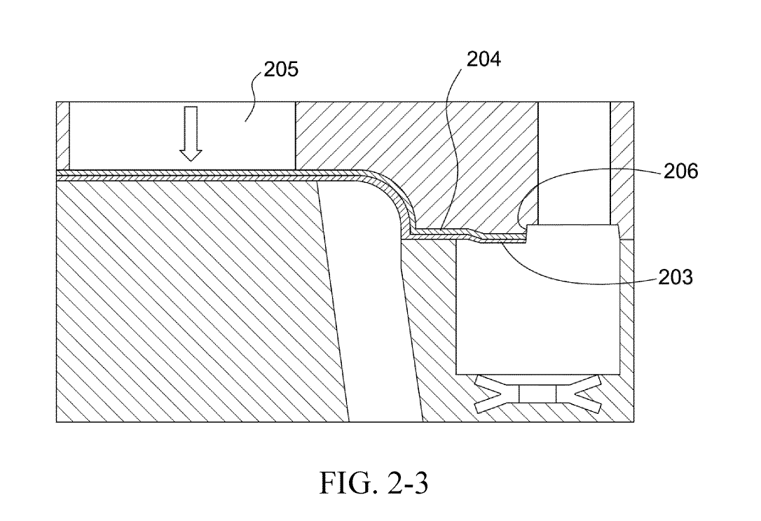

FIG. 2-1 and FIG. 2-2 illustrate a device 201 for manufacturing a workpiece with multiple metal layers, for carrying out the method shown in FIG. 1. The device 201 includes a mold 202 with a front mold 208 and a rear mold 207. The mold 202 is shown in FIG. 2-1 in an open configuration in which the front mold 208 and the rear mold 207 are detached from each other. A semi-finished metal cover 203 (constituting a first metal layer) formed of a first metal is disposed on the rear mold 207 of the mold 202. FIG. 2-2 shows the mold 202 in a closed configuration in which the semi-finished cover 203 is held between the front mold 208 and the rear mold 207. When the mold 202 is in the closed configuration, a second metal in liquid form 2041 (which is a different metal from that of the first metal layer 203) is injected onto the semi-finished cover 203 in the mold 202, so as to form a second metal layer 204 on the cover 203.

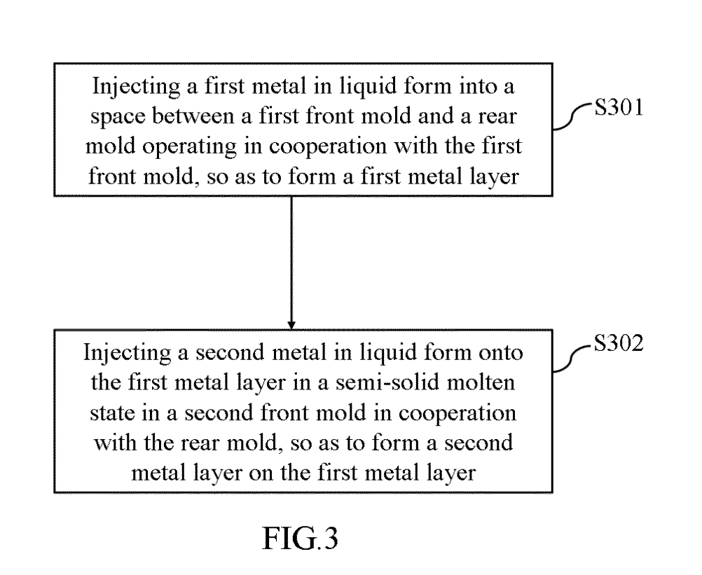

FIG. 2-3 is a partially enlarged view of FIG. 2-2, and shows that the mold 202 includes a pressing component 205 for applying a pressure on the second metal layer 204 in the mold 202.

In a further embodiment, a space is provided between the rear mold 207 and the pressing component 205, so that the second metal in liquid form 2041 may be injected into the space. Moreover, the mold 202 additionally includes an overflow port 206, so that a surplus of the second metal in liquid form 2041 overflows through the overflow port 206 when the pressing component 205 presses the second metal layer 204.

Although, in the foregoing discussions, it is mentioned that the first metal is different from the second metal, it is of course envisaged that the first metal layer and the second metal layer may be made of a same metal.

In a yet further embodiment of the present invention, and as shown in FIG. 3, a method of manufacturing a workpiece with multiple metal layers includes steps of injecting a first metal in liquid form into a space between a rear mold and a first front mold in cooperation with each other, so as to form a first metal layer on the rear mold (S301), and when the rear mold operates in cooperation with a second front mold and when the first metal layer on the rear mold is in a semi-solid molten state, injecting a second metal in liquid form onto the first metal layer so as to form a second metal layer on the first metal layer (S302). Again, the first metal layer and the second metal layer may be made of the same or different metals.

The difference between the method shown in FIG. 3 and the method shown in FIG. 1 lies mainly in that, in the method shown in FIG. 3, the second metal in liquid form is injected onto the first metal layer and the second metal layer is formed when the first metal layer is still in a semi-solid molten state. This not only improves the adhesiveness between the first metal layer and the second metal layer, but also reduces cost and saves time, thereby improving the yield.

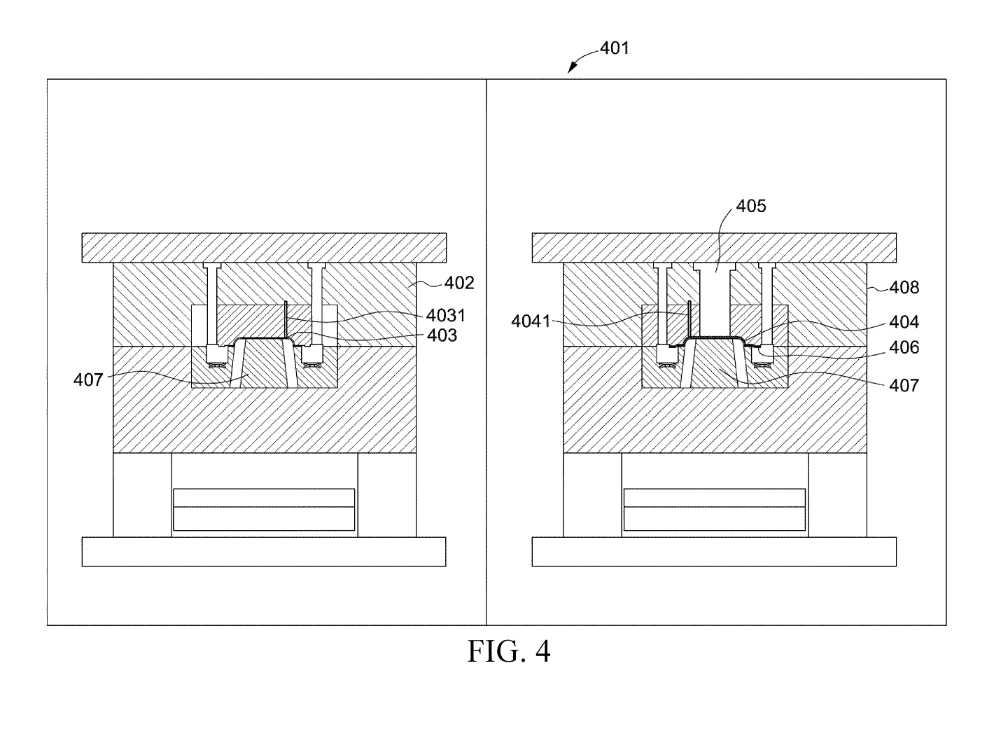

A device 401 for implementing the method shown in FIG. 3 is shown in FIG. 4. As shown in FIG. 4, the device 401 includes a first front mold 402 which can operate in cooperation with a rear mold 407, and inject a first metal in liquid form 4031 onto the rear mold 407, so as to form a first metal layer 403 on the rear mold 407. The device 401 also includes a second front mold 408, which is co-operable with the rear mold 407 to inject a second metal in liquid form 4041 onto the first metal layer 403 when the first metal layer 403 is still in a semi-solid molten state, so as to form a second metal layer 404 on the first metal layer 403.

When the second front mold 408 operates in cooperation with the rear mold 407, a space is provided between the rear mold 407 and a pressing component 405, so that the second metal in liquid form 4041 may be injected into the space.

Moreover, the pressing component 405 in the second front mold 408 may be used for applying a pressure on the second metal layer 404. Furthermore, the rear mold 407 further includes an overflow port 406, so that a surplus of the second metal in liquid form 4031 may overflow through the overflow port 406 when the pressing component 405 applies a pressure on the second metal layer 404.

The device 401 further includes a movement component, for relatively moving the rear mold 407 between the first front mold 402 and the second front mold 408. For example, the rear mold 407 may be moved from the first front mold 402 to the second front mold 408 after the first metal in liquid form 4031 is injected; or the first front mold 402 is moved away after the first metal in liquid form 4031 is injected, and the second front mold 408 is moved to a position operating in cooperation with the rear mold 407, so as to inject the second metal in liquid form 4041 onto the first metal layer 403. Through this arrangement, the injection of both the first metal in liquid form 4031 and the second metal in liquid form 4041 is performed in the same device 401, thus simplifying the production process.

A workpiece with three or more metal layers may be formed by repeating the above steps.

Each of the first metal layer and the second metal layer may be formed of stainless steel, iron, zinc, aluminum, magnesium, chromium, titanium, copper, beryllium, nickel and alloy of these metals. A first metal layer with a smaller specific weight may first be formed, and then a second metal layer with a larger specific weight is formed. Alternatively, a first metal layer with a larger specific weight may first be formed, and then a second metal layer with a smaller specific weight is formed. For example, if the first metal layer is formed of a zinc alloy, and the second metal layer is formed of an aluminum alloy, the strength of a composite metal may be achieved, and subsequent anodizing surface treatment may be performed on the second metal (aluminum alloy) layer. In another example, the first metal layer is formed of an aluminum alloy or a magnesium alloy, and the second metal layer is formed of stainless steel, so that subsequent treatment such as direct current electroplating or vacuum evaporation may be conveniently performed on a surface of the second metal layer, thereby further forming a subsequent metal or non-metal layer.

Not only does the workpiece with multiple metal layers manufactured according to a method of the present invention have the strength and elasticity of a composite metal, but also subsequent surface treatment (such as heat treatment, anodizing surface treatment, Galvanic plating, vacuum coating/film treatment, coating treatment, painting treatment, and corrosion resistant treatment) may be performed on the metal workpiece, as required, to further improve the adhesiveness between the metal layers and the strength and corrosion resistance of the workpiece, and to make the design of covers made of such workpieces more flexible.

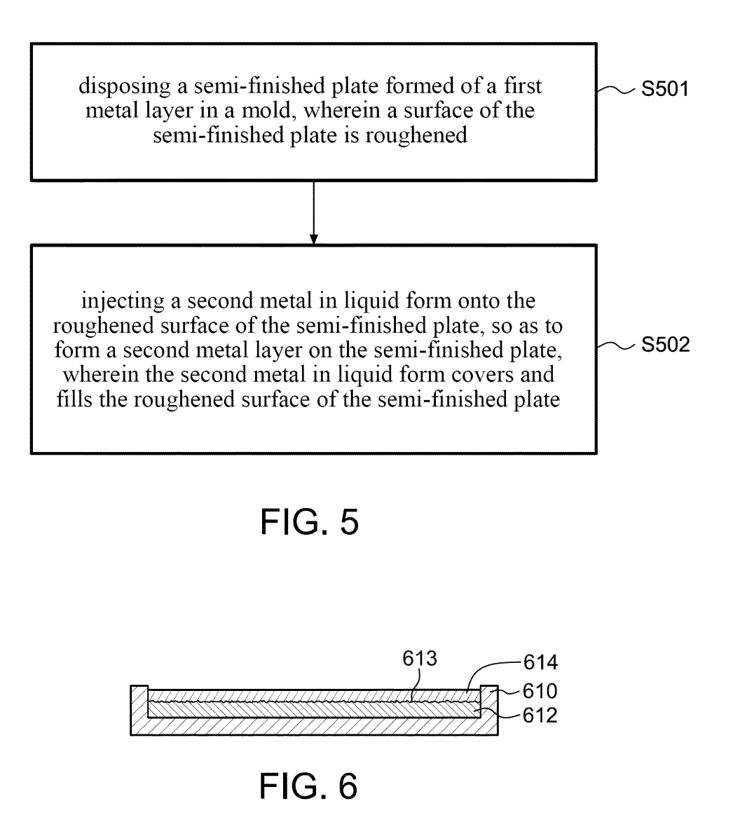

A method of manufacturing a workpiece with multiple metal layers, according to a yet further embodiment of the present invention is shown in FIG. 5. The method shown in FIG. 5 includes steps of disposing a semi-finished metal workpiece (such as a plate formed of a first metal layer) in a mold, in which a surface of the semi-finished workpiece is roughened (S501). Subsequently, a second metal in liquid form is injected onto the roughened surface of the semi-finished workpiece, so as to form a second metal layer on the semi-finished workpiece, in which the second metal in liquid form covers and fills the roughened surface of the semi-finished plate (S502). The roughened surface of the semi-finished plate can be formed on either a cosmetic surface or an inner surface of the semi-finished plate. A third metal in liquid form may be injected onto the second metal layer to form a three-layer metal plate by repeating the above operation.

FIG. 6 shows a plate with multiple metal layers manufactured by the method shown in FIG. 5. As shown in FIG. 6, a semi-finished plate 612 formed of a first metal is disposed in a mold 610. A surface 613 of the semi-finished plate 612 is roughened. A second metal in liquid form is injected onto the roughened surface 613 of the semi-finished plate 612, to form a second metal layer 614 on the semi-finished plate 612 which sufficiently covers and fills the roughened surface 613 of the semi-finished plate 612. Such an arrangement increases the adhesive strength between the semi-finished plate 612 and the second metal layer 614. The semi-finished plate 612 and the second metal layer 614 may be made of the same metal or different metals. The roughened surface 613 of the semi-finished plate 612 may be formed of a plurality of recesses, holes, grooves, balls or protrusions or a combination of these. The roughened surface 613 of the semi-finished plate 612 may be formed mechanically and/or chemically. By way of such an arrangement, detachment of the semi-finished plate 612 and the second metal layer 614 from each other is at least hindered.

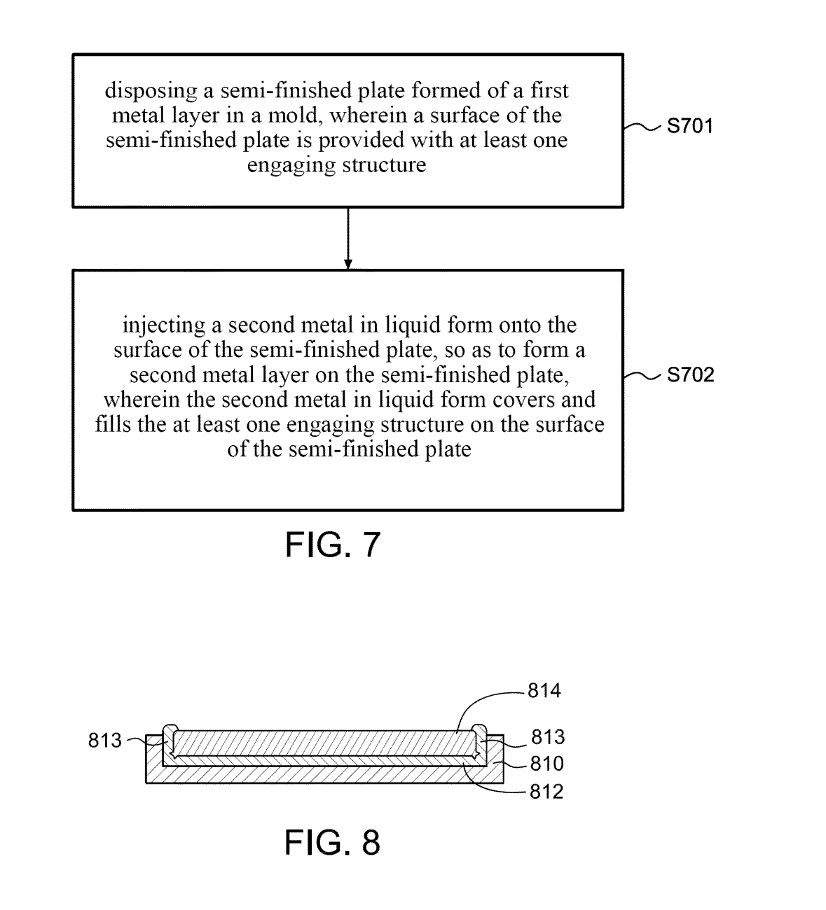

FIG. 7 shows a method according to a still further embodiment of the present invention. This method includes disposing a semi-finished plate formed of a first metal in a mold, in which a surface of the semi-finished plate is provided with at least one engaging structure (S701), and injecting a second metal in liquid form onto the surface of the semi-finished plate, so as to form a second metal layer on the semi-finished plate, in which the second metal in liquid form caps, fills and engages with the engaging structure on the surface of the semi-finished plate (S702). The engaging structure of the semi-finished plate can be formed on either a cosmetic surface or an inner surface of the semi-finished plate. A third metal in liquid form may be injected onto the second metal layer to form a three-layer metal plate by repeating the operation.

FIG. 8 illustrates a plate with multiple metal layers manufactured according to the method shown in FIG. 7. As shown in FIG. 8, a semi-finished metal plate 812 formed of a first metal is disposed in a mold 810. A surface of the semi-finished plate 812 is formed with at least one engaging structure 813. The engaging structure 813 may be a hook, a buckle, a trench, a protrusion, a groove or a combination of these structures. A second metal in liquid form is injected onto the surface of the semi-finished plate 812, to form a second metal layer 814 on the semi-finished plate 812 which sufficiently caps, fills and engages with the engaging structure 813 on the surface of the semi-finished plate 812. By way of such an arrangement, at least part of the second metal layer 814 is confined to a space defined by the engaging structure 813, so as to fix the semi-finished plate 812 with the second metal layer 814. Such an arrangement at least hinders detachment of the semi-finished plate 812 and the second metal layer 814 from each other.

In molding, the molten molding material (such as a molten metal) is injected from an injector nozzle of a molding machine to flow through a sprue, then a runner, then a gate, through which the molten molding material enters the cavity of the mold. More particularly, a sprue is a channel allowing flow of the molten molding material from the injector nozzle towards the mold cavity. A runner is a channel in fluid communication with the sprue and guides the molten molding material to flow from the sprue towards the mold cavity. The runner is joined with the gate and the gate acts as an entrance through which molten molding material in the runner enters the mold cavity.

To further enhance the strength of bonding/engagement between the first metal layer and second metal layer, in an embodiment of the present invention, the second metal in liquid form is injected from the injector nozzle at such a speed that the second metal in liquid form exits the runner and enters the cavity of the mold via the gate of the mold at a speed of at least 70 meters per second (m/s). This speed will hereafter be called the “ex-gate speed”. In one embodiment, to achieve an ex-gate speed of 70 m/s, it is arranged such that the second metal in liquid form exits the sprue and enters the runner at a speed of at least 3.5 m/s. This latter speed will hereafter be called the “ex-sprue speed”.

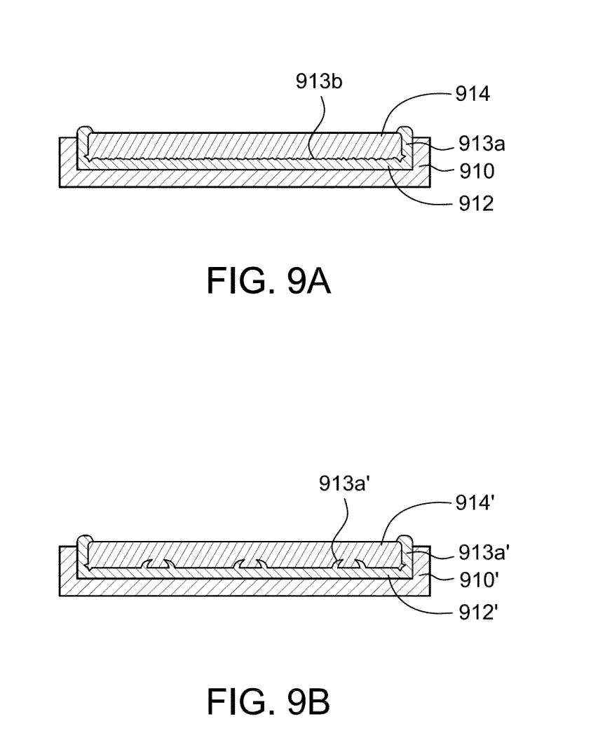

FIG. 9A illustrates a plate with multiple metal layers according to an embodiment of the present invention. A semi-finished plate 912 formed of a first metal is first disposed in a mold 910. A surface 913b of the semi-finished plate 912 is roughened to form a plurality of recesses, holes, grooves, balls and/or protrusions, and at least one engaging structure 913a in the form of a hook, buckle, trench, protrusion and/or groove is also formed on the surface 913b. A second metal in liquid form is injected onto the roughened surface 913b and the at least one engaging structure 913a of the semi-finished plate 912 at an ex-gate speed of at least 70 m/s, to form a second metal layer 914 on the semi-finished plate 912 which sufficiently covers and fills the roughened surface 913b and engages the at least one engaging structure 913a of the semi-finished plate 912, so as to increase the joining and bonding or engagement strength between the semi-finished plate 912 and the second metal layer 914 and to confine part of the second metal layer 914 within a space defined by the engaging structure(s) 913a.

FIG. 9B illustrates a plate with multiple metal layers according to another embodiment of the present invention. A semi-finished plate 912′ formed of a first metal is first disposed in a mold 910′. A surface of the semi-finished plate 912′ is formed with at least one engaging structure 913a′ in the form of a hook, a buckle, a trench, a protrusion and/or a groove. A second metal in liquid form is injected onto the engaging structure 913a′ of the semi-finished plate 912′ at an ex-gate speed of at least 70 m/s, to form a second metal layer 914′ on the semi-finished plate 912′ which sufficiently covers, fills and engages with the engaging structure 913a′ of the semi-finished plate 912′. Such an arrangement increases the joining and bonding or engagement strength between the semi-finished plate 912′ and the second metal layer 914′ and confines part of the second metal layer 914′ within a space defined by the engaging structure(s) 913a′. More particularly, bonding or engagement between the semi-finished plate 912′ and the second metal layer 914′ is enhanced because the inter-engagement and/or interlocking between the second metal layer 914′ and the engaging structure 913a′ hinders detachment of the semi-finished plate 912′ and the second metal layer 914′ from each other. More particularly, it can be said that each of the semi-finished plate 912′ and the second metal layer 914′ has at least one engagement structure which engage with each other.

The semi-finished plate (or the first metal layer) and the second metal layer may be made of the same metal or different metals, and the metal may be stainless steel, iron, zinc, aluminum, magnesium, chromium, titanium, copper, beryllium, nickel or an alloy thereof.

The roughened surface of the semi-finished plate (i.e. first metal layer) in the above embodiments may be formed chemically and/or mechanically. For example, if the first metal layer is formed of aluminum (Al), anodizing process may be used for forming pores on the surface of first metal layer for joining with the molten second metal. In particular, the second metal in molten state may be trapped in the pores, so that the second metal will be fastened onto the first metal layer after cooling and curing thereof.

The plate may be used as a cover or an insert of an electronic device, or any other kinds of products/devices in other industries in which the devices require better joining, bonding or engagement strength on multi-metal construction.

The first metal layer and the second metal layer may be engaged together by bonding or confining a part of the second metal layer in a space defined by the engaging structure.

In above-mentioned methods, the second metal 614, 814, 914 and 914′ may be injected onto the surface of the semi-finished plate (first metal layer) at an ex-gate speed of at least 70 m/s, and with an ex-sprue speed higher than 3 m/s, 3.5 m/s, 4.0 m/s, 4.5 m/s, 5.5 m/s, 6.0 m/s, 6.5 m/s or above. In this way, the second metal layer can be of an extremely thin dimension, so that the recesses, holes, grooves, balls or protrusions of the roughened surface and hook(s), buckle(s), trench(es), protrusion(s) or groove(s) of the engaging structure can be well capped (or covered) and filled by the second metal. In a preferred embodiment, the thickness of the second metal layer may be not more than 0.5 mm (such as 0.5 mm, 0.3 mm, 0.2 mm or 0.1 mm) by adjusting the ex-gate speed (e.g. by adjusting the speed at which the second molten metal is ejected from the injection nozzle), or depending on the 3D-design of product, which may become important in future.

In view of the above, high speed of flow of the second molten metal is a critical parameter in minimizing the fall in temperature of the second molten metal during its flow from the injection nozzle to the mold cavity. Localized melting on the surfaces of the two metals which are going to be joined or bonded together can only result in a weak bonding. As such, post-processes (for examples, laser welding, resistance welding and some other welding processes which are known in the market) are needed to enhance the joining or bonding strength between the two metal layers. In the present invention, a bolted locking mechanism (or bolted locking space) is provided on the first metal layer for guiding the second metal in molten form to be trapped by the designated space defined by the bolted locking mechanism, as the engaging structures 913a and 913a′ depicted in FIGS. 9A-9B and discussed above.

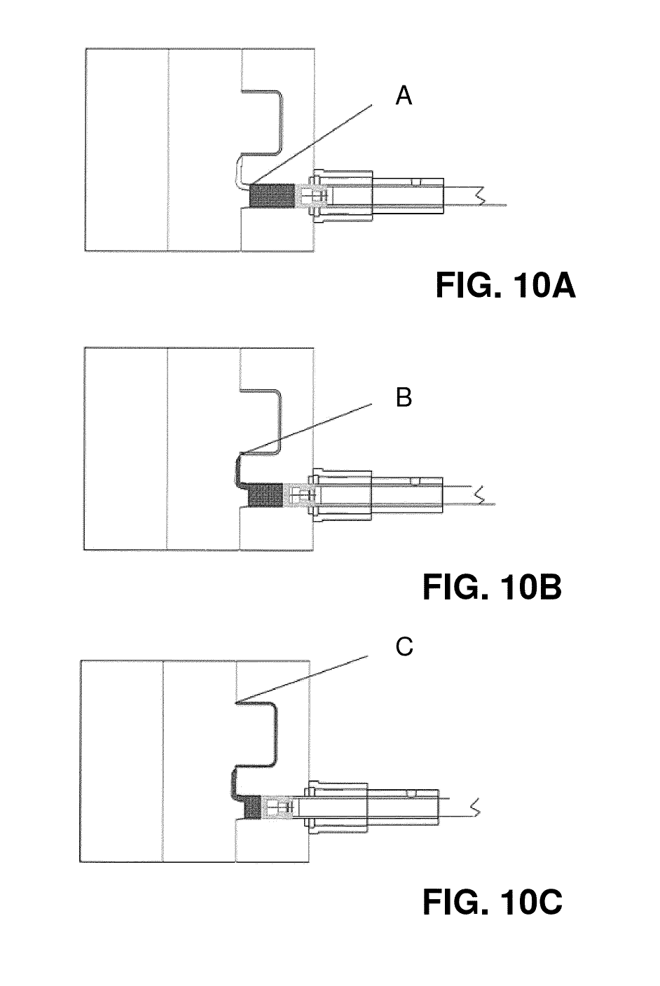

In particular, a purpose of injecting the second metal in liquid form into the mold at a high speed is to ensure that the second metal fills up the cavity in a very short time, and thus the second metal is still in the molten stage when it fills up the cavity of the mold to form the second metal layer. As shown in the example illustrated in FIGS. 10A to 10C, the total time duration starting from that shown in FIG. 10A (when the molten second metal exits the sprue and enters the runner, at point A), through that shown in FIG. 10B (when the molten second metal has passed through the runner and is about to enter the gate, at point B), until that shown in FIG. 10C (when the molten second metal fills up the cavity of the mold, at point C) is not more than 0.02 s, with a total displacement of 130 mm. Of this time duration of 0.02 s, the time duration which the molten second metal takes to fill up the cavity only is not more than 0.005 s after it enters the cavity of the mold. In this example, the speed at which the molten second metal exits the sprue and enters the runner is 3.5 m/s, and the speed at which the molten second metal exits the gate and enters the cavity of the mold is 70 m/s.

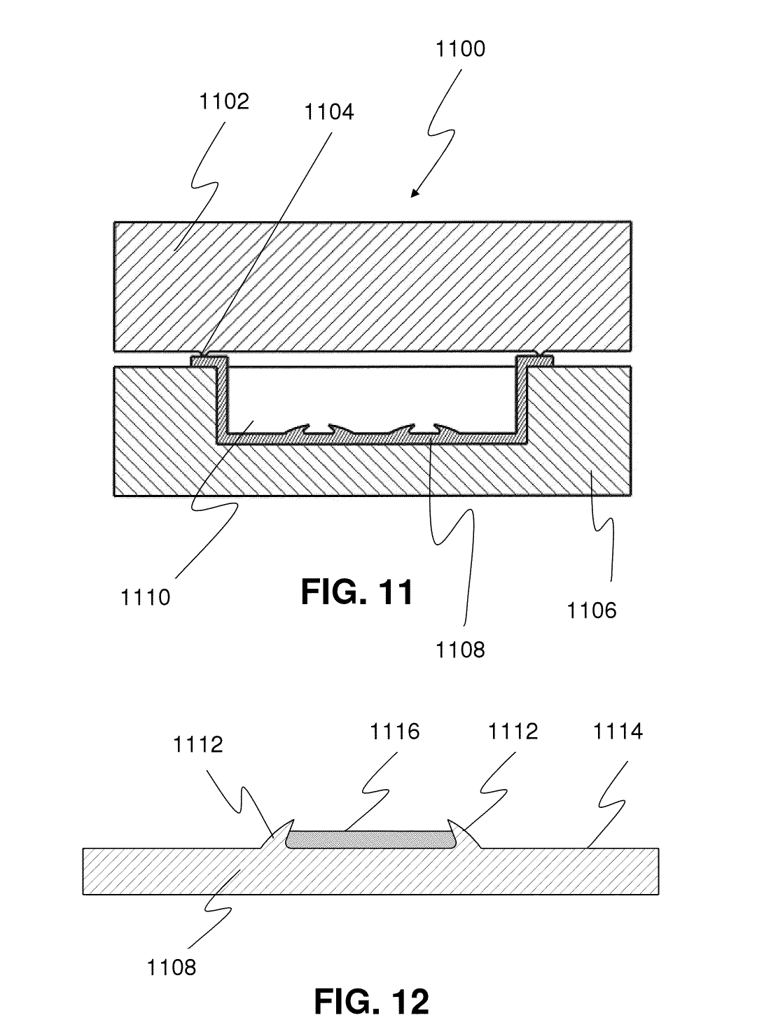

To further enhance the engagement and bonding between the two metal layers, as shown in FIG. 11, a mold 1100 for manufacturing a plate with multiple metal layers according to this invention has an upper mold 1102 with a barrier in the form of an endless wall 1104 which extends away from a surface of the upper mold 1102 directly facing a lower mold 1106. When the upper mold 1102 is in the configuration shown in FIG. 11, in which the upper mold 1102 is aligned with the lower mold 1106 and a semi-finished metal plate 1108 (being a first metal layer) ready for injection of the second metal in molten form is held between the upper mold 1102 and the lower mold 1106, the wall 1104 contacts and is pressed to cut into the semi-finished plate 1108 to form a seal which prevents flow of a fluid (including a gas and a liquid) through the seal. The gas may be air and the liquid may be a liquid molding material, such as the second metal in molten form. A space 1110 is also formed between the upper mold 1102 and the semi-finished plate 1108. The space 1110 is in a fluid-communicable relationship with the injector nozzle via the sprue, runner and gate of the mold. The space 1110 reduces further oxidation of the molten second metal during its flow in the mold. Because of the high speed at which the second metal in molten form exits the gate and enters the cavity, and with the help of the space 1110 (which reduces further oxidation of the second metal in molten form), the molten second metal can engage with and/or penetrate the roughened surface and/or the engagement element on the semi-finished plate 1108 in a very short period of time, say of no more than 0.005 s, after it has entered the space 1110, to thereby enhance the strength of engagement between the two layers of metal (meaning the semi-finished plate 1108 and the metal layer formed of the cooled-down second metal). On the other hand, in the absence of the wall 1104 and, thus, the fluid-proof seal between the wall 1104 and the semi-finished plate 1108, due to the connection of the outside atmosphere and the cavity through the traditional air venting system, the molten second metal will further be further cooled down and oxidized during the injection process. The surface of the molten second metal will become oxidized and will be extended to the coming molten second metal. The surface tension of the oxidized molten second metal and/or semi-solid second metal will be higher, causing higher viscosity of the molten second metal, which will slow down the flow of the molten second metal. It will then be difficult for the molten second metal to penetrate or engage with the engagement elements of the semi-finished plate 1108, in particular if such engagement elements are of a height of less than 0.5 mm and a width of less than 0.5 mm, or engagement elements of a depth of at least 0.5 mm.

Although the engagement elements may be of a height of at least 0.5 mm, the second metal layer may be of a lesser thickness. As shown in FIG. 12, the semi-finished plate 1108 is schematically shown with two engagement elements, each being a hook 1112, which are spaced apart from each other. The hooks 1112 extend from an upper surface 1114 of the plate 1108 by a height of 0.5 mm. A volume of molten second metal is injected into the space between the hooks 1112 to form a second metal layer 1116 engaged with the plate 1108. Depending on the structural and design requirements, the thickness of the second metal layer 1116 may be more than, equal to, or less than the height of the hooks 1112. In particular, in FIG. 12, the second metal layer 1116 is shown as being of a thickness (e.g. 0.4 mm, 0.3 mm or less) which is less than the height of the hooks 1112.

The mold 1100 includes a passageway through which molding materials (such as molten metals) may be supplied to the cavity of the mold when the mold 1100 is in the closed configuration. As distinct from existing practice, however, there is no channel in the mold 1100 through which excess molding material (i.e. the molten metal) exits the cavity of the mold 1100 to become burrs and flash, which have to be trimmed off after the molding process. On the other hand, when the mold 1100 is used, any excess molten second metal will flow over the first metal layer/plate 1108 and will still form part of the product. It is thus not necessary to carry out any trimming step after the method according to this invention, because there is no “over-flow material” to be trimmed off.

Although FIG. 11 shows the wall 1104 as being provided by the upper mold 1102, it is envisaged that, depending on the designs of the products, the wall 1104 may be provided by the lower mold 1106, e.g. on a surface facing directly the upper mold 1102.

A method according to this invention possesses at least the following advantages:
(a) the molded product can be ejected after the injection process, which is different from the ordinary casting process in which the product has to be cooled down before it can be ejected from the cavity,
(b) the molten second metal covers the first metal layer when the molten second metal is still in liquid form,
(c) further oxidation of the molten second metal before it is cooled down is reduced, thus allowing the molten second metal to fully engage with or penetrate into different parts of the roughened surface and/or engagement elements (such as grooves, pores, recesses) of the semi-finished plate (being a first metal layer). It provides the opportunity to form the interior features in net shape and to reduce a lot of post-treatment processes and CNC works, thus saving further cost,
(d) as all the molten metal is trapped, with no overflow of such metal, the edges around the first and second metal layers become dense and sealed. There is thus no gap between the metal layers, in particular between the boundaries or between the joining lines of the metal layers, which is observable by end users, thus ensuring cosmetic quality. In addition to being a cosmetic treatment for the product, such also prevents liquid (such as water, DI water, acidic solutions, alkaline solutions or the like) from seeping between the metal layers. This at least reduces the potential problem of galvanic corrosion of the product,
(e) in cases where the workpiece is to form the outer casing of a finished product, the surface which will form the outside surface of the finished product will have no trace of the injected material, thus presenting a more aesthetically pleasing outlook, and
(f) as the second metal layer can be very thin (of not more than 0.5 mm), if a workpiece is to form a casing of a product, space of the interior of the product is saved, thus allowing more freedom to the designers.

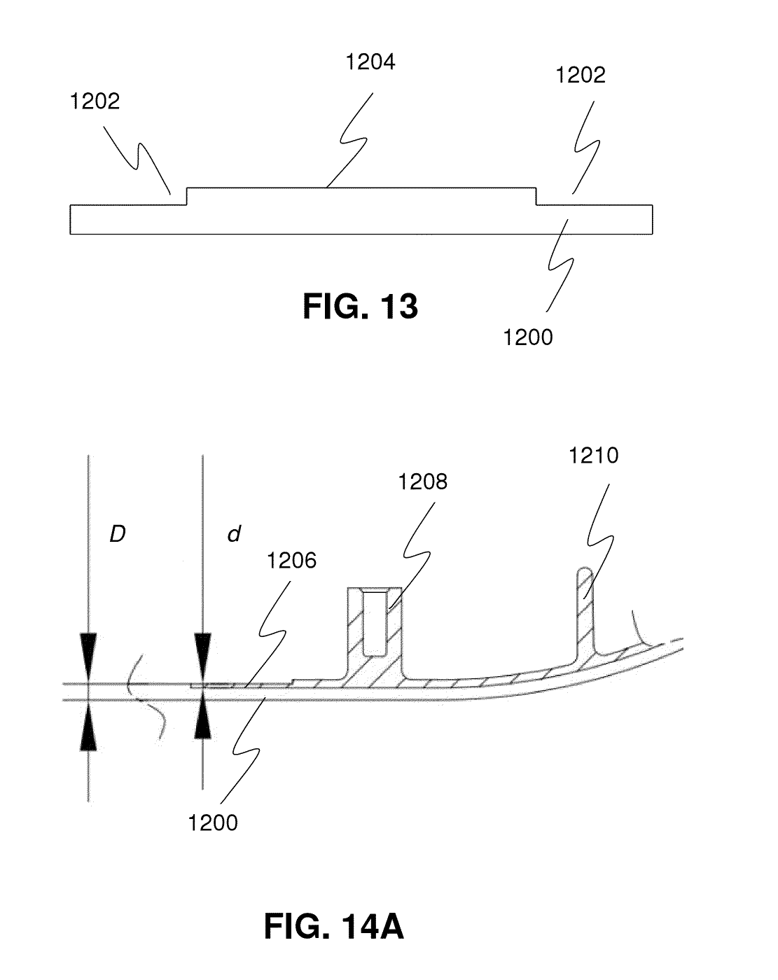

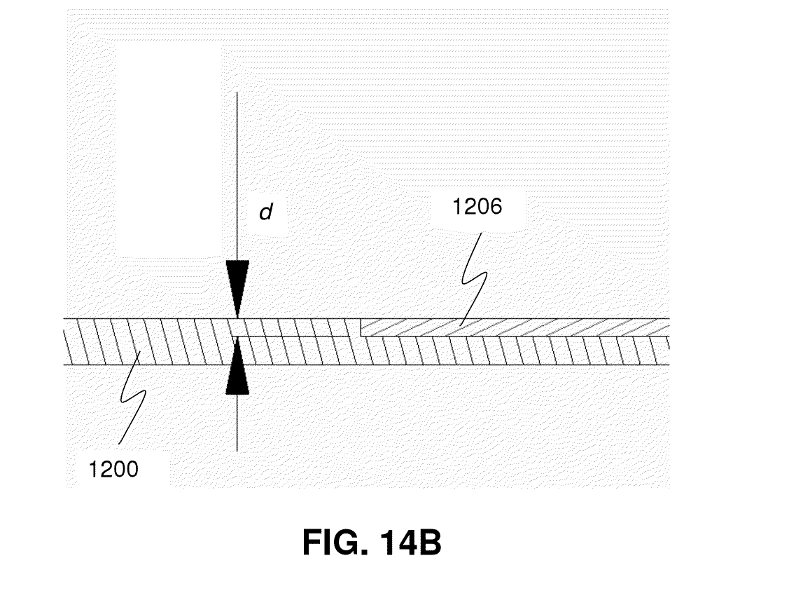

In a further embodiment of the present invention, and as shown in FIGS. 13 to 14B, a first metal layer (e.g. a semi-finished plate 1200) is pre-treated before molding. The plate 1200, which is made of a first metal, is originally of a generally rectangular cross-section. The semi-finished plate 1200 conforms generally with the shape and contour (in particular the outer contour) of the component which it is intended to form. Some of the first metal is removed from the plate 1200 to form one or more recesses, e.g. thin bays 1202, on an upper surface 1204 of the plate 1200. These bays 1202 are of a depth d of 0.3 mm or less, while the thickness D of the first metal layer 1200 is around 0.8 mm.

The pre-treated semi-finished plate 1200 is then placed within the cavity of a mold. A molten second metal is then injected onto the upper surface 1204 of the pre-treated plate 1200 to form a second metal layer 1206, and to engage with the pre-treated plate 1200 to form a bi-layer metal workpiece. Some of the second metal is received within the bays 1202 of the plate 1200, so as to engage the pre-treated plate 1200 with the second metal layer 1206. It is of course possible to form a workpiece with more layers of metal by repeating the above steps. It should be noted that the second metal layer 1206 may cover only part of the bays 1202.

In addition, and as shown in FIG. 14A, because of the high speed at which the molten second metal is injected onto the upper surface 1204 of the plate 1200, the second metal layer 1206 so formed by the second metal can form structures which extend away from a major surface of the second metal layer 1206 of the plate 1200. Such structures may be screw boss 1208 and other mechanical, structural components 1210.

It is found in practice that this arrangement of pre-treating the semi-finished plate 1200 (in particular the removal of some of the first metal from the plate 1200 to form two recesses in the form of thin bays 1202 on the upper surface 1204 of the plate 1200) before molding may be advantageously combined with the use of mold 1100 with the endless wall 1104 discussed above. With such a combined method, there will be no “waste material”, as any excess molten second metal (i.e. molten second metal beyond the minimum amount necessary for molding onto the first metal layer) will be kept within the mold 1100 to form at least part of the second metal layer 1206, which forms useful parts of the final workpiece/product.

An advantage associated with adopting such a combined method is that all excess or surplus molten second metal (if any) will become part of the final workpiece/product in a planned manner, which could assist in strengthening the features formed by the second metal. In addition, as it is not necessary to post-treat any overflow material, the combined method is both environmentally-friendly and cost-saving.

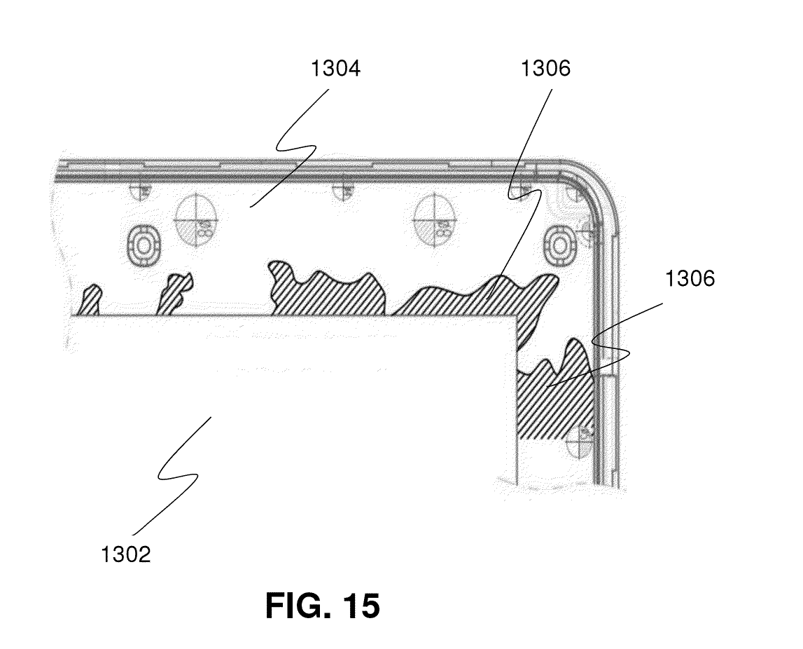

As mentioned above, the second metal layer 1206 may cover only part of the bays formed on the first metal layer. As shown in FIG. 15, a cover 1302 formed of a first metal layer is formed with a shallow bay 1304 along the periphery. Molten second metal is then molded on the first metal layer to form a second metal layer, in such a way that part of the bay 1304 is covered by the molten second metal. Hashed areas 1306 shown in FIG. 15 are areas of the thin 1304 not covered by the molten second metal. During the molding process, the bay 1304 receives the molding material (i.e. molten second metal) and performs air-venting function for leaking air generated during the molding process.

The present invention seeks to at least mitigate the shortcomings associated with the prior art, and to manufacture a workpiece with multiple metal layers at a lower cost and with a higher yield, by preparing materials according to actual material consumption, thus being more environmentally friendly and cost efficient than the technology currently available. Meanwhile, different metals of double layers or multiple layers may be designed to completely or partially cover a substrate, so as to meet the requirements for appearance and mechanical performance at the same time, which will save a large amount of work in developing different alloy materials and save global resources.

The method of the present invention achieves good adhesiveness between multiple metal layers and improves the metal compactness and the surface smoothness, and facilitates subsequent metal surface treatment.

It should also be understood that, for the purpose of this invention, a “workpiece with multiple metal layers” does not mean that the workpiece is formed exclusively of metal(s). It is envisaged that a “workpiece with multiple metal layers” may be formed additionally of other materials, e.g. plastics material. As an example, such a workpiece may be formed of two metal layers which are bonded/engaged with each other as discussed above and a plastic layer which is bonded/engaged with one of the two metal layers. There is thus no limitation on the number of layers of materials involved or the number of materials involved, so long as the workpiece includes two metal layers which are bonded/engaged with each other as discussed above.

Although the technical contents and features of the present invention are described above, various variations and modifications can be made by persons of ordinary skill in the art without departing from the teaching and disclosure of the present invention. Therefore, the scope of the present invention is not limited to the disclosed embodiments, but encompasses other variations and modifications that do not depart from the present invention as defined by the appended claims.

What is claimed is:

1. A workpiece with multiple metal layers, said workpiece being formed by injecting at least a second metal layer onto a first metal layer, wherein each of said first metal layer and second metal layer includes at least one engagement structure.

2. The workpiece according to claim 1 wherein said at least one engagement structure of said first metal layer engages with said at least one engagement structure of said second metal layer.

3. The workpiece according to claim 1 wherein said engagement structure of said first metal layer and said engagement structure of said second metal layer are independently selected from a group including a recess, a hole, a groove, a hook, a buckle, a trench, a ball and a protrusion.

4. The workpiece according to claim 3 wherein each of said first metal layer and said second metal layer is made of a metal independently selected from a group including stainless steel, iron, zinc, aluminum, magnesium, chromium, titanium, copper, beryllium, nickel and alloys thereof.

5. The workpiece according to claim 1 wherein said workpiece is a plate.

6. The workpiece according to claim 5 wherein said plate is a cover or an insert of an electronic device.

7. The workpiece according to claim 1 wherein said second metal layer is of a thickness of not more than substantially 0.5 mm.

8. The workpiece according to claim 1 wherein said second metal layer includes at least one part which extends away from a major surface of said second metal layer.

9. A workpiece with multiple metal layers, said workpiece being formed by injecting at least a second metal layer onto a first metal layer, wherein said second metal layer is of a thickness of not more than substantially 0.5 mm.
